(19) United States
(12) Patent Application Publication
(10) Pub. No.: US 2011/0311144 A1
(43) Pub. Date: Dec. 22, 2011

(54) RGB/DEPTH CAMERA FOR IMPROVING SPEECH RECOGNITION

(75) Inventor: John A. Tardif, Sammamish, WA (US)

(73) Assignee: MICROSOFT CORPORATION, Redmond, WA (US)

(21) Appl. No.: 12/817,854

(22) Filed: Jun. 17, 2010

(51) Int. Cl. H04N 5/228; G10L 15/00; G06K 9/46

(52) U.S. Cl. 382/195; 348/222.1; 704/251; 704/E15.001; 348/E05.031

(57) ABSTRACT

A system and method are disclosed for facilitating speech recognition through the processing of visual speech cues. These speech cues may include the position of the lips, tongue and/or teeth during speech. In one embodiment, upon capture of a frame of data by an image capture device, the system identifies a speaker and a location of the speaker. The system then focuses in on the speaker to get a clear image of the speaker's mouth. The system includes a visual speech cues engine which operates to recognize and distinguish sounds based on the captured position of the speaker's lips, tongue and/or teeth. The visual speech cues data may be synchronized with the audio data to ensure the visual speech cues engine is processing image data which corresponds to the correct audio data.

### BACKGROUND

In the past, computing applications such as computer games and multimedia applications used controllers, remotes, keyboards, mice, or the like to allow users to manipulate game characters or other aspects of an application. More recently, computer games and multimedia applications have begun employing cameras and software gesture recognition engines to provide a natural user interface (“NUT”). With NUI, user gestures are detected, interpreted and used to control game characters or other aspects of an application.

In addition to gestures, a further aspect of NUI systems is the ability to receive and interpret audio questions and commands. Speech recognition systems relying on audio alone are known, and do an acceptable job on most audio. However, certain phonemes such as for example “p” and “t”; “s” and “sh” and “f”, etc. sound alike and are difficult to distinguish. This exercise becomes even harder in situations where there is limited bandwidth or significant background noise. Additional methodologies may be layered on top of audio techniques for phoneme recognition, such as for example word recognition, grammar and syntactical parsing and contextual inferences. However, these methodologies add complexity and latency to speech recognition.

### SUMMARY

Disclosed herein are systems and methods for facilitating speech recognition through the processing of visual speech cues. These speech cues may include the position of the lips, tongue and/or teeth during speech. In one embodiment, upon capture of a frame of data by an image capture device, the system identifies a speaker and a location of the speaker. The system then focuses in on the speaker to get a clear image of the speaker's mouth. The system includes a visual speech cues engine which operates to recognize and distinguish sounds based on the captured position of the speaker's mouth, tongue and/or teeth. The visual speech cues data may be synchronized with the audio data to ensure the visual speech cues engine is processing image data which corresponds to the correct audio data.

The present technology may simplify the speech recognition process. The present system may operate with existing depth and RGB cameras and adds no overhead to existing systems. On the other hand, the present system may allow for speech recognition without having to employ word recognition, grammar and syntactical parsing, contextual inferences and/or a variety of other processes which add complexity and latency to speech recognition. Thus, the present technology may simplify and improve processing times for speech recognition.

In one embodiment, the present technology relates to a method of recognizing phonemes from image data. The method includes the steps of: a) receiving information from the scene including image data and audio data; b) identifying a speaker in the scene; c) locating a position of the speaker within the scene; d) obtaining greater image detail on speaker within the scene relative to other areas of the scene; e) capturing image data relating to a position of at least one of the speaker's lips, tongue and/or teeth; and f) comparing the image data captured in said step e) against stored rules to identify a phoneme.

In another embodiment, the present technology relates to a method of recognizing phonemes from image data, including the steps of: a) receiving information from the scene including image data and audio data; b) identifying a speaker in the scene; c) locating a position of the speaker within the scene; d) measuring a plurality of parameters to determine whether a clarity threshold is met for obtaining image data relating to a position of at least one of the speaker's lips, tongue and/or teeth; e) capturing image data relating to a position of at least one of the speaker's lips, tongue and/or teeth if it is determined in said step d) that the clarity threshold is met; and f) identifying a phoneme indicated by the image data captured in said step e) if it is determined in said step d) that the clarity threshold is met.

In a further embodiment, the present technology relates to a computer-readable storage medium for programming a processor to perform a method of recognizing phonemes from image data. The method includes the steps of: a) capturing image data and audio data from a capture device; b) setting a frame rate at which the capture device captures images sufficient to capture lips, tongue and/or teeth positions when forming a phoneme with minimal motion artifacts; c) setting a resolution of the image data to a resolution that does not result in latency in the frame rate set in said step b); d) prompting a user to move to a position close enough to the capture device for the resolution set in said step c) to obtain an image of the user's lips, tongue and/or teeth with enough clarity to discern between different phonemes; e) capturing image data from the user relating to a position of at least one of the speaker's lips, tongue and/or teeth; and f) identifying a phoneme based on the image data captured in said step e).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A illustrates an example embodiment of a target recognition, analysis, and tracking system.

FIG. 1B illustrates a further example embodiment of a target recognition, analysis, and tracking system.

FIG. 2 illustrates an example embodiment of a capture device that may be used in a target recognition, analysis, and tracking system.

FIG. 3A illustrates an example embodiment of a computing environment that may be used to interpret one or more gestures in a target recognition, analysis, and tracking system.

FIG. 3B illustrates another example embodiment of a computing environment that may be used to interpret one or more gestures in a target recognition, analysis, and tracking system.

FIG. 4 illustrates a skeletal mapping of a user that has been generated from the target recognition, analysis, and tracking system of FIGS. 1A-2.

FIG. 5 is a flowchart of a first embodiment of a visual cue speech recognition system according to the present technology.

FIG. 6 is a flowchart of a second embodiment of a visual cue speech recognition system according to the present technology.

FIG. 7 is a flowchart of a third embodiment of a visual cue speech recognition system according to the present technology.

FIG. 8 is an image captured by a capture device of a scene.

FIG. 9 is an image showing focus on a user's head within a scene.

FIG. 10 is an image showing greater focus on a user's mouth within a scene.

FIG. 11 is a block diagram showing a visual speech cues engine for recognizing phonemes.

FIG. 12 is a flowchart of the operation of the visual speech cues engine of FIG. 11.

### DETAILED DESCRIPTION

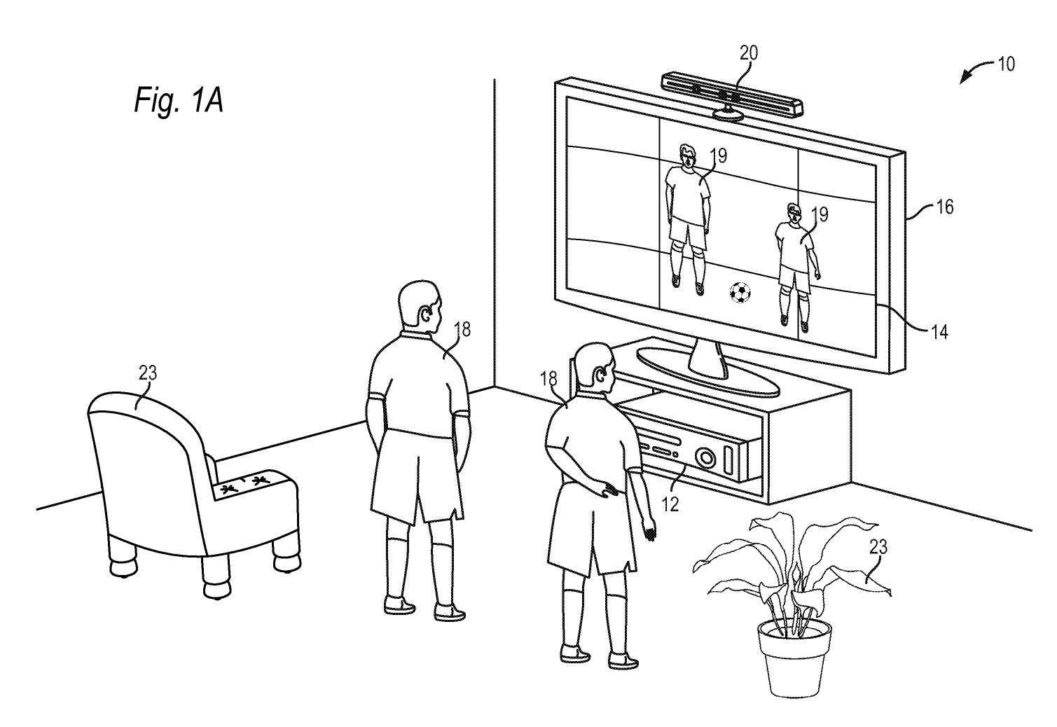

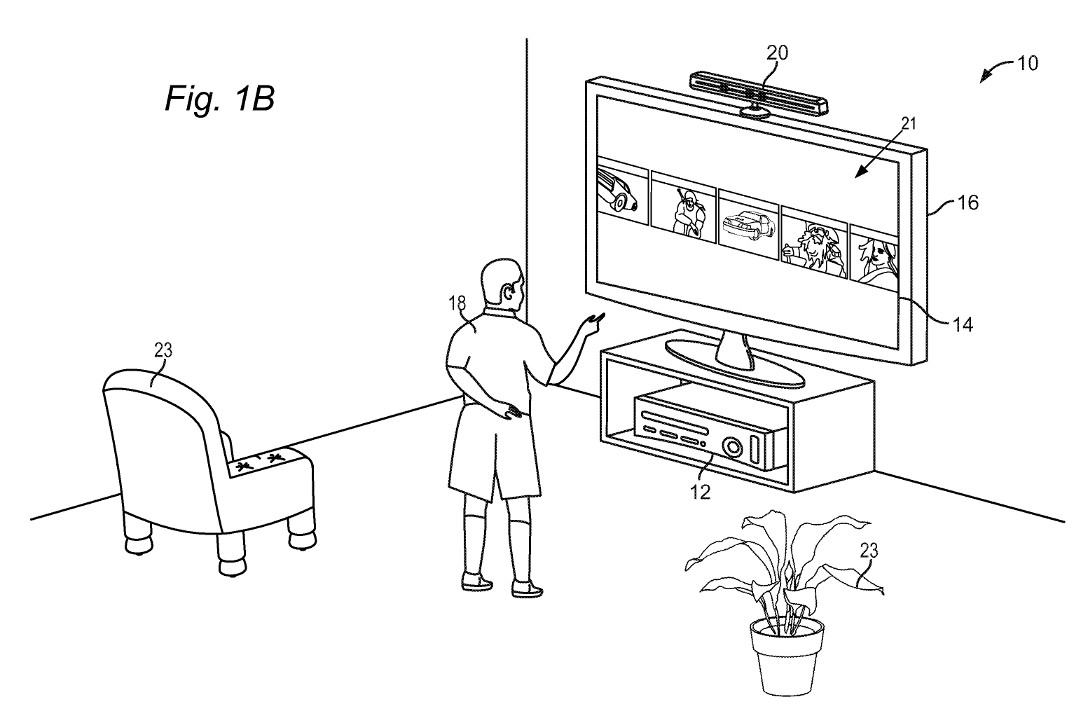

Embodiments of the present technology will now be described with reference to FIGS. 1A-12, which in general relate to a system and method for facilitating speech recognition through the processing of visual speech cues. These speech cues may include the position of the lips, tongue and/or teeth during speech. While certain phonemes are difficult to recognize from an audio perspective, the lips, tongue and/or teeth may be formed into different, unique positions for each phoneme. These positions may be captured in image data and analyzed against a library of cataloged rules to identify a specific phoneme from the position of the lips, tongue and/or teeth.

In one embodiment, upon capture of a frame of data by an image capture device, the system identifies a speaker and a location of the speaker. Speak location may be determined from the images, and/or from the audio positional data (as generated in a typical microphone array). The system then focuses in on the speaker to get a clear image of the speaker's mouth. The system includes a visual speech cues engine which operates to recognize and distinguish sounds based on the captured position of the speaker's lips, tongue and/or teeth. The visual speech cues data may be synchronized with the audio data to ensure the visual speech cues engine is processing image data which corresponds to the correct audio data.

The present technology is described below in the context of a NUI system. However, it is understood that the present technology is not limited to a NUI system and may be used in any speech recognition scenario where both an image sensor and audio sensor are used to detect and recognize speech. As another example, a camera may be attached to a microphone to aid in identifying spoken or sung phonemes in accordance with the present system explained below.

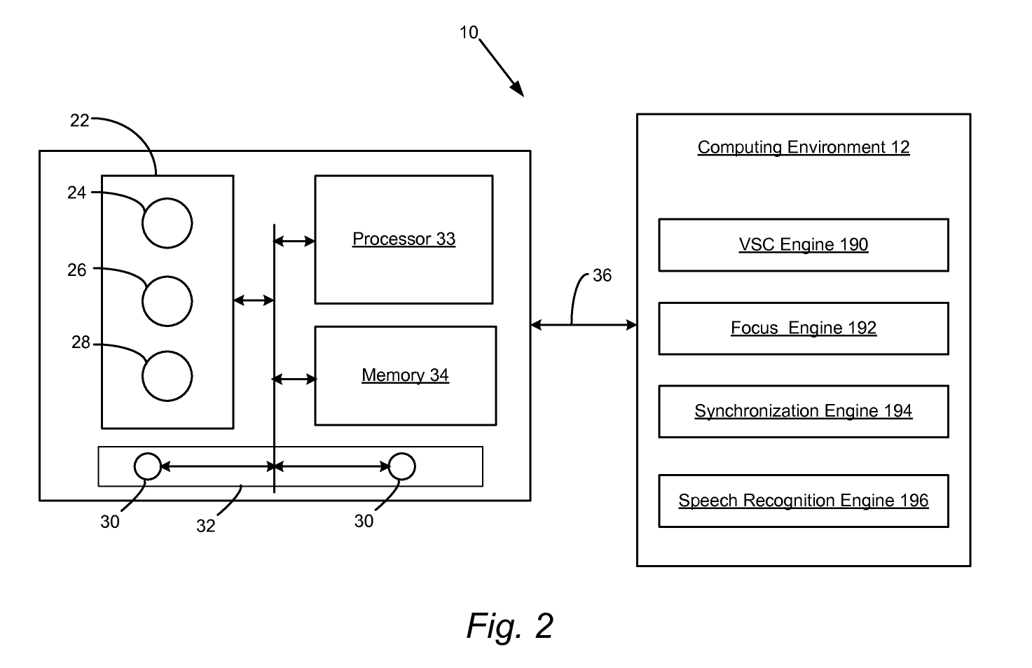

Referring initially to FIGS. 1A-2, when implemented with a NUI system, the present technology may include a target recognition, analysis, and tracking system 10 which may be used to recognize, analyze, and/or track a human target such as the user 18. Embodiments of the target recognition, analysis, and tracking system 10 include a computing environment 12 for executing a gaming or other application. The computing environment 12 may include hardware components and/or software components such that computing environment 12 may be used to execute applications such as gaming and non-gaming applications. In one embodiment, computing environment 12 may include a processor such as a standardized processor, a specialized processor, a microprocessor, or the like that may execute instructions stored on a processor readable storage device for performing processes described herein.

The system 10 further includes a capture device 20 for capturing image and audio data relating to one or more users and/or objects sensed by the capture device. In embodiments, the capture device 20 may be used to capture information relating to movements, gestures and speech of one or more users, which information is received by the computing environment and used to render, interact with and/or control aspects of a gaming or other application. Examples of the computing environment 12 and capture device 20 are explained in greater detail below.

Embodiments of the target recognition, analysis, and tracking system 10 may be connected to an audio/visual device 16 having a display 14. The device 16 may for example be a television, a monitor, a high-definition television (HDTV), or the like that may provide game or application visuals and/or audio to a user. For example, the computing environment 12 may include a video adapter such as a graphics card and/or an audio adapter such as a sound card that may provide audio/visual signals associated with the game or other application. The audio/visual device 16 may receive the audio/visual signals from the computing environment 12 and may then output the game or application visuals and/or audio associated with the audio/visual signals to the user 18. According to one embodiment, the audio/visual device 16 may be connected to the computing environment 12 via, for example, an S-Video cable, a coaxial cable, an HDMI cable, a DVI cable, a VGA cable, a component video cable, or the like.

In embodiments, the computing environment 12, the AN device 16 and the capture device 20 may cooperate to render an avatar or on-screen character 19 on display 14. In embodiments, the avatar 19 mimics the movements of the user 18 in real world space so that the user 18 may perform movements and gestures which control the movements and actions of the avatar 19 on the display 14.

In FIG. 1A, the capture device 20 is used in a NUI system where, for example, a pair of users 18 are playing a soccer game. In this example, the computing environment 12 may use the audiovisual display 14 to provide a visual representation of two avatars 19 in the form of soccer players controlled by the respective users 18. A user 18 may move or perform a kicking motion in physical space to cause their associated player avatar 19 to move or kick the soccer ball in game space. The users may also interact with the system 10 though voice commands and responses. Thus, according to an example embodiment, the computing environment 12 and the capture device 20 may be used to recognize and analyze movements, voice and gestures of the users 18 in physical space, and such movements, voice and gestures may be interpreted as a game control or action of the user's associated avatar 19 in game space.

The embodiment of FIG. 1A is one of many different applications which may be run on computing environment 12, and the application running on computing environment 12 may be a variety of other gaming and non-gaming applications. Moreover, the system 10 may further be used to interpret user 18 movements and voice commands as operating system (OS) and/or application controls that are outside the realm of games or the specific application running on computing environment 12. One example is shown in FIG. 1B, where a user 18 is scrolling through and controlling a user interface 21 with a variety of menu options presented on the display 14. The user may scroll through the menu items with physical gestures and/or voice commands. Virtually any controllable aspect of an operating system and/or application may be controlled by the movements and/or voice of the user 18.

Suitable examples of a system 10 and components thereof are found in the following co-pending patent applications, all of which are hereby specifically incorporated by reference: U.S. patent application Ser. No. 12/475,094, entitled “Environment And/Or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; U.S. patent application Ser. No. 12/391,150, entitled “Standard Gestures,” filed Feb. 23, 2009; and U.S. patent application Ser. No. 12/474,655, entitled “Gesture Tool,” filed May 29, 2009.

FIG. 2 illustrates an example embodiment of the capture device 20 that may be used in the target recognition, analysis, and tracking system 10. In an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as a grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

According to another embodiment, the capture device 20 may include two or more physically separated cameras that may view a scene from different angles, to obtain visual stereo data that may be resolved to generate depth information. In another example embodiment, the capture device 20 may use point cloud data and target digitization techniques to detect features of the user 18.

The capture device 20 may further include a microphone array 32. The microphone array 32 receives voice commands from the users 18 to control their avatars 19, affect other game or system metrics, or control other applications that may be executed by the computing environment 12. In the embodiment shown, there are two microphones 30, but it is understood that the microphone array may have one or more than two microphones in further embodiments. The microphones 30 in the array may be positioned near to each other as shown in the figures, such as for example one foot apart. The microphones may be spaced closer together, or farther apart, for example at the corners of a wall to which the capture device 20 is adjacent.

The microphones 30 in the array may be synchronized with each other. As explained below, the microphones may provide a time stamp to a clock shared by the image camera component 22 so that the microphones and the depth camera 26 and RGB camera 28 may each be synchronized with each other. The microphone array 32 may further include a transducer or sensor that may receive and convert sound into an electrical signal. Techniques are known for differentiating sounds picked up by the microphones to determine whether one or more of the sounds is a human voice. Microphones 30 may include various known filters, such as a high pass filter, to attenuate low frequency noise which may be detected by the microphones 30.

In an example embodiment, the capture device 20 may further include a processor 33 that may be in operative communication with the image camera component 22 and microphone array 32. The processor 33 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instructions. The processor 33 may further include a system clock for synchronizing image data from the image camera component 22 with audio data from the microphone array. The computing environment may alternatively or additionally include a system clock for this purpose.

The capture device 20 may further include a memory component 34 that may store the instructions that may be executed by the processor 33, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 33. According to another embodiment, the memory component 34 may be integrated into the processor 33 and/or the image camera component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. A variety of known techniques exist for determining whether a target or object detected by capture device 20 corresponds to a human target. Skeletal mapping techniques may then be used to determine various spots on that user's skeleton including the user's head and mouth, joints of the hands, wrists, elbows, knees, nose, ankles, shoulders, and where the pelvis meets the spine. Other techniques include transforming the image into a body model representation of the person and transforming the image into a mesh model representation of the person.

The skeletal model may then be provided to the computing environment 12 such that the computing environment may perform a variety of actions. The computing environment may further determine which controls to perform in an application executing on the computer environment based on, for example, gestures of the user that have been recognized from the skeletal model and/or audio commands from the microphone array 32. The computing environment 12 may for example include a gesture recognition engine, explained for example in one or more of the above patents incorporated by reference.

Moreover, in accordance with the present technology, the computing environment 12 may include a visual speech cues (VSC) engine 190 for recognizing phonemes based on movement of the speaker's mouth. The computing environment 12 may further include a focus engine 192 for focusing on a speaker's head and mouth as explained below, and a speech recognition engine 196 for recognizing speech from audio signals. Each of the VSC engine 190, focus engine 192 and speech recognition engine 196 are explained in greater detail below. Portions, or all, of the VSC engine 190, focus engine 192 and/or speech recognition engine 196 may be resident on capture device 20 and executed by the processor 33 in further embodiments.

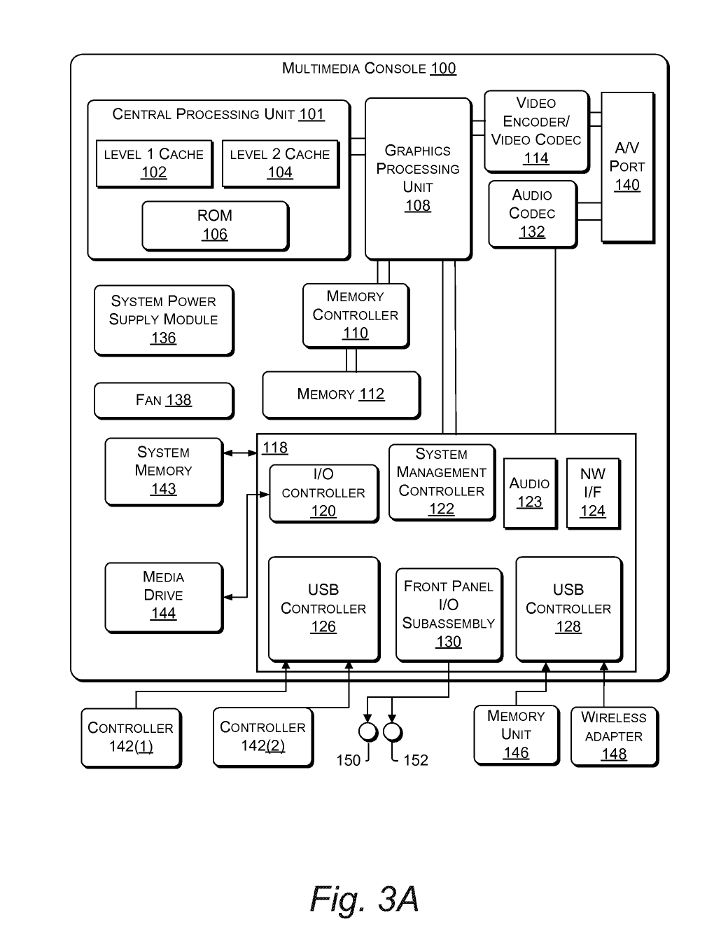

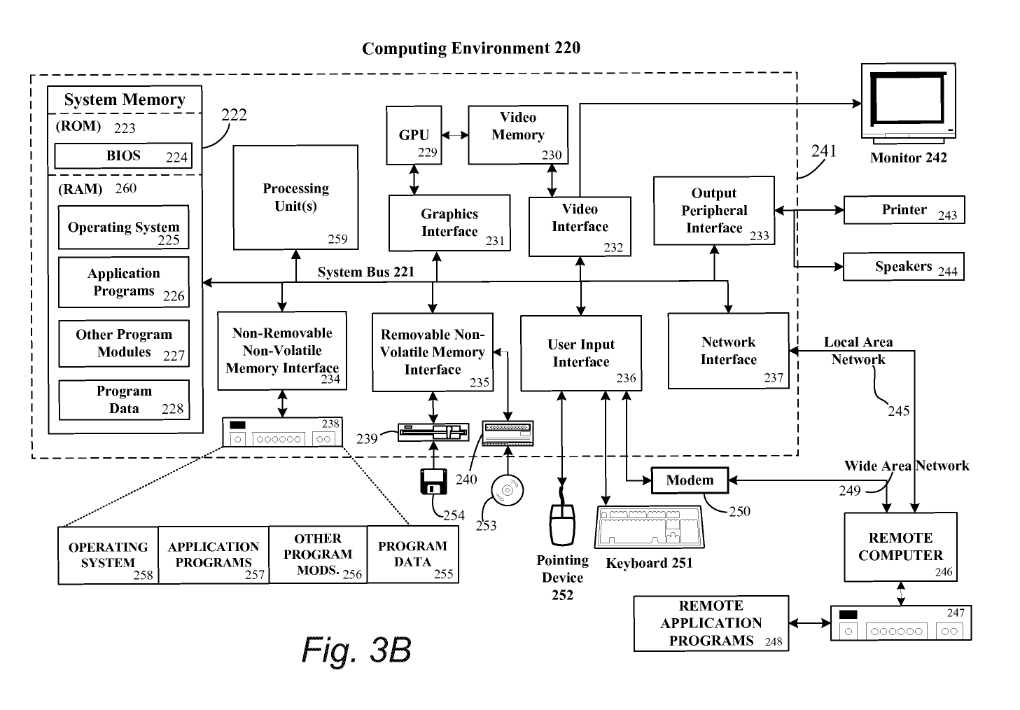

FIG. 3A illustrates an example embodiment of a computing environment that may be used to interpret one or more positions and motions of a user in a target recognition, analysis, and tracking system. The computing environment such as the computing environment 12 described above with respect to FIGS. 1A-2 may be a multimedia console 100, such as a gaming console. As shown in FIG. 3A, the multimedia console 100 has a central processing unit (CPU) 101 having a level 1 cache 102, a level 2 cache 104, and a flash ROM 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an AN (audio/video) port 140 for transmission to a television or other display. A memory controller 110 is connected to the GPU 108 to facilitate processor access to various types of memory 112, such as, but not limited to, a RAM.

The multimedia console 100 includes an I/O controller 120, a system management controller 122, an audio processing unit 123, a network interface controller 124, a first USB host controller 126, a second USB host controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the AN port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 100.

FIG. 3B illustrates another example embodiment of a computing environment 220 that may be the computing environment 12 shown in FIGS. 1A-2 used to interpret one or more positions and motions in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 3B, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as ROM 223 and RAM 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 3B illustrates operating system 225, application programs 226, other program modules 227, and program data 228. FIG. 3B further includes a graphics processor unit (GPU) 229 having an associated video memory 230 for high speed and high resolution graphics processing and storage. The GPU 229 may be connected to the system bus 221 through a graphics interface 231.

The computer 241 may also include other removable/non-removable, volatile/nonvolatile computer storage media. By way of example only, FIG. 3B illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 3B, provide storage of computer readable instructions, data structures, program modules and other data for the computer 241. In FIG. 3B, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and a pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 3B. The logical connections depicted in FIG. 3B include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 3B illustrates remote application programs 248 as residing on memory device 247. It will be appreciated that the network connections shown are exemplary and other means of establishing a communications link between the computers may be used.

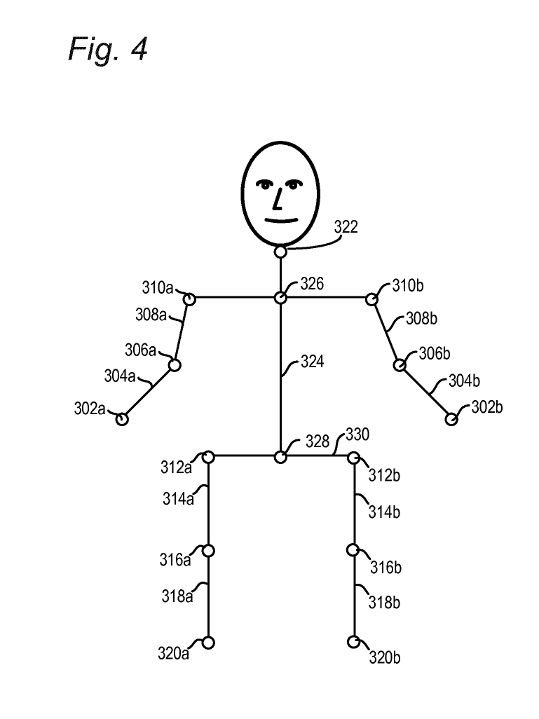

FIG. 4 depicts an example skeletal mapping of a user that may be generated from the capture device 20. In this embodiment, a variety of joints and bones are identified: each hand 302, each forearm 304, each elbow 306, each bicep 308, each shoulder 310, each hip 312, each thigh 314, each knee 316, each foreleg 318, each foot 320, the head 322, the torso 324, the top 326 and the bottom 328 of the spine, and the waist 330. Where more points are tracked, additional features may be identified, such as the bones and joints of the fingers or toes, or individual features of the face, such as the nose and eyes.

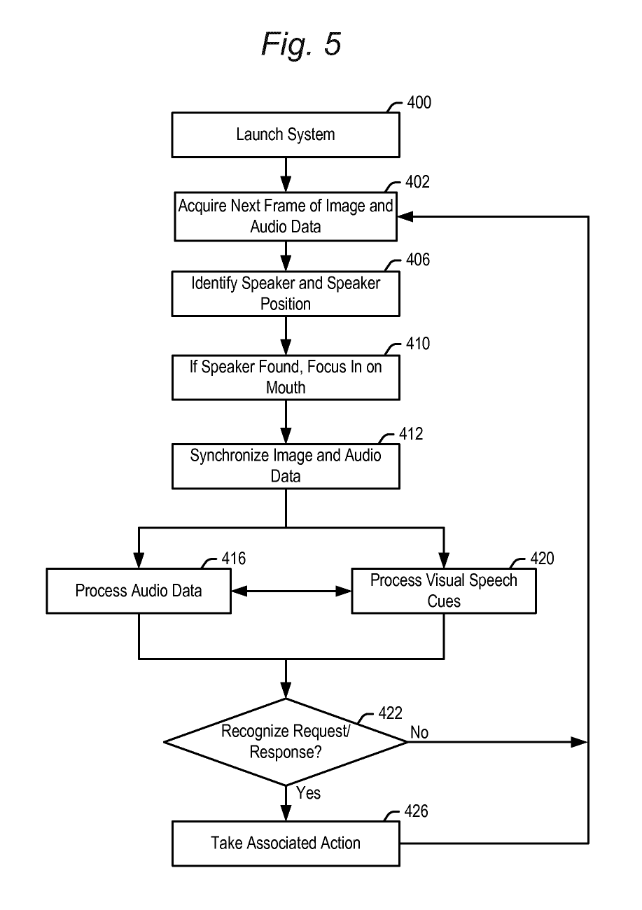

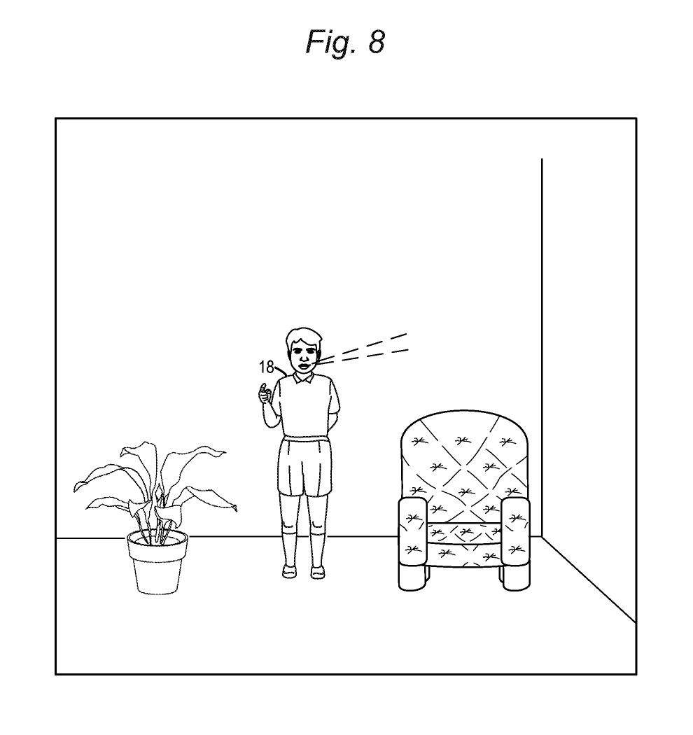

As indicated in the Background section, it may at times be difficult to perform voice recognition from audio data by itself. The present technology includes the VSC engine 190 for performing phoneme recognition and/or augmenting voice recognition by the voice recognition engine 196. FIG. 5 shows the operation of a first embodiment of the present technology. The system 10 may be launched in step 400 and the capture device 20 may acquire the next frame of data in step 402. The data in step 402 may include image data from the depth camera 26, RGB camera 28, and audio data from microphone array 32. FIG. 8 shows an illustration of a scene including the user 18 captured by capture device 20 in step 402. In step 406, the computing environment 12 analyzes the data to detect whether a user is speaking and, if so, determines a location of the speaker in 3-D world space. This may be done by known techniques, including for example by combination of voice analysis and identification techniques, acoustic source localization techniques and image analysis. A speaker in the field of view may be located by other methods in further embodiments.

In step 410, if a speaker is found, one or both of the depth camera 26 and RGB camera 28 may focus in on a head of the speaker. In order to catch all of the movements of the speaker's lips, tongue and/or teeth, the capture device 20 may refresh at relatively high frame rates, such as for example 60 Hz, 90 Hz, 120 Hz or 150 Hz. It is understood that the frame rate may be slower, such as for example 30 Hz, or faster than this range in further embodiments. In order to process the image data at higher frame rates, the depth camera and/or RGB camera may need to be set to relatively low resolutions, such as for example 0.1 to 1 MP/frame. At these resolutions, it may be desirable to zoom in on a speaker's head, as explained below, to ensure a clear picture of the user's mouth.

While the embodiment described in FIG. 5 may include step 410 of zooming in, it is understood that the zoom step 410 may be omitted in further embodiments and the depth and/or RGB cameras may capture images of the speaker's mouth at their normal field of view perspective. In embodiments, a user may be positioned close enough to the capture device 20 that no zoom is needed. As explained below, the light energy incident on the speaker may also factor into the clarity of an image the depth and/or RGB cameras are able to obtain. In embodiments, existing depth cameras and/or RGB cameras may have their own light source projected onto a scene. In such instances, a user may be 6 feet away from the capture device 20 or less, though the user may be farther than this in further embodiments.

The focusing of step 410 may be performed by the focus engine 192 and accomplished by a variety of techniques. In embodiments, the depth camera 26 and RGB camera 28 operate in unison to zoom in on the speaker's head to the same degree. In further embodiments, they need not zoom together. The zooming of image camera component 22 may be an optical (mechanical) zoom of a camera lens, or it may be a digital zoom where the zoom is accomplished in software. Both mechanical and digital zoom systems for cameras are known and operate to change the focal length (either literally or effectively) to increase the size of an image in the field of view of a camera lens. An example of a digital zoom system is disclosed for example in U.S. Pat. No. 7,477,297, entitled “Combined Optical And Digital Zoom,” issued Jan. 13, 2009 and incorporated by reference herein in its entirety. The step of focusing may further be performed by selecting the user's head and/or mouth as a “region of interest.” This functionality is known in standard image sensors, and it allows for an increased refresh rate (to avoid motion artifacts) and/or turning off compression (MJPEG) to eliminate compression artifacts.

Further techniques for zooming in on an area of interest are set forth in applicant's co-pending patent application Ser. No. ______, entitled “Compartmentalizing Focus Area Within Field of View,” (Attorney Docket No. MSFT-01350US0), which application is incorporated by reference herein in its entirety.

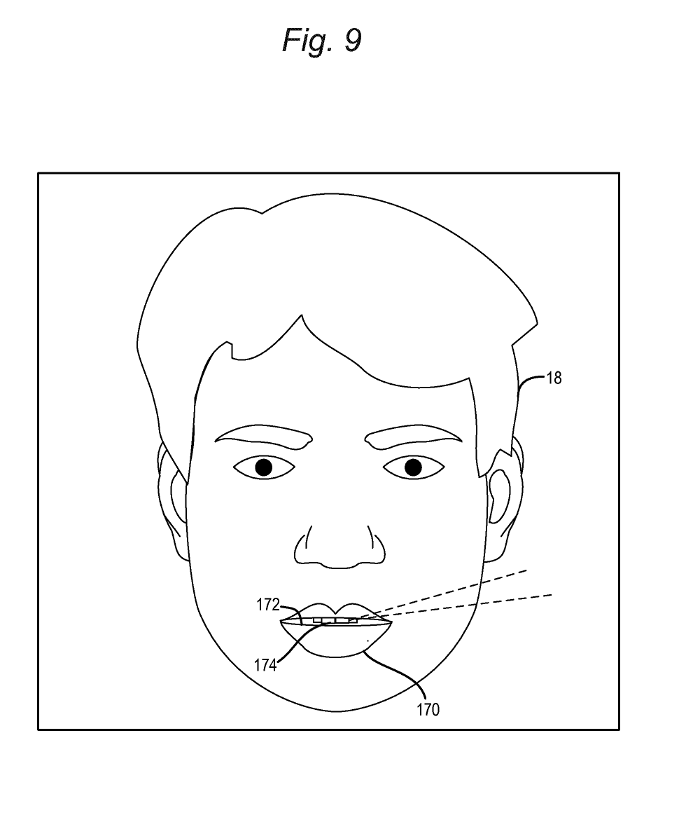

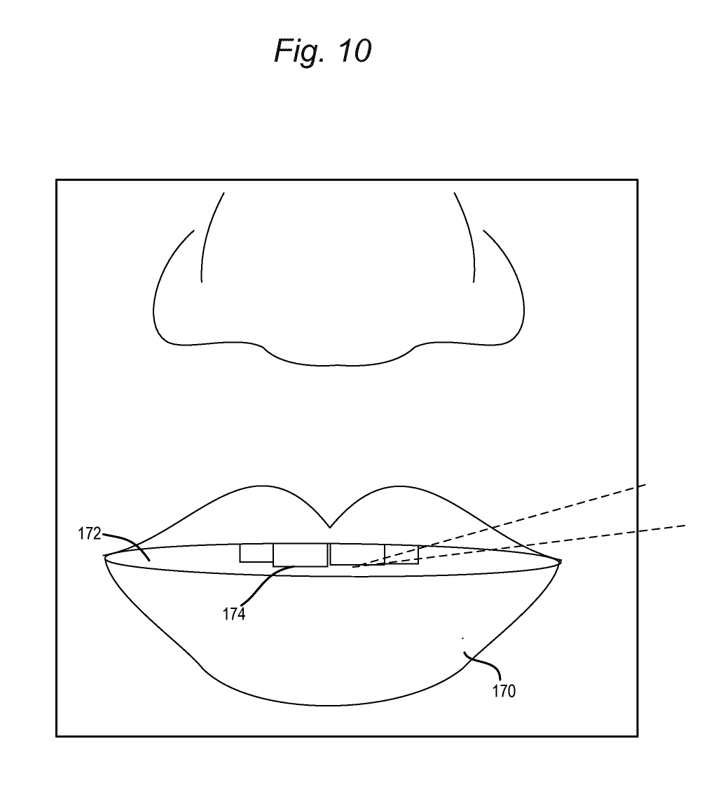

The cameras 26, 28 may zoom in on the speaker's head, as shown in FIG. 9, or the cameras 26, 28 may zoom in further to a speaker's mouth, as shown in FIG. 10. Regardless of zoom factor, the depth camera 26 and/or RGB camera 28 may get a clear image of the mouth of a user 18, including lips 170, tongue 172 and/or teeth 174. It is understood that the cameras may operate to capture image data anywhere between the perspectives of FIG. 8 (no zoom) to FIG. 10 (zoom in specifically on the speaker's mouth).

In step 412, the image data obtained from the depth and RGB cameras 26, 28 are synchronized to audio data received in microphone array 32. This may be accomplished by both the audio data from microphone array 32 and the image data from depth/RGB cameras getting time stamped at the start of a frame by a common clock, such as a clock in capture device 20 or in computing environment 12. Once the image and audio data at the start of a frame is time stamped off of a common clock, any offset may be determined and the two data sources synchronized. It is contemplated that a synchronization engine may be used to synchronize the data from any of the depth camera 26, RGB camera 28 and microphone array 32 with each other.

Once the audio and image data is synchronized in step 412, the audio data may be sent to the speech recognition engine 196 for processing in step 416, and the image data of the user's mouth may be sent to the VSC engine 190 for processing in step 420. The steps 416 and 420 may occur contemporaneously and/or in parallel, though they need not in further embodiments. As noted in the Background section, the speech recognition engine 196 typically will be able to discern most phonemes. However, certain phonemes and fricatives may be difficult to discern by audio techniques, such as for example “p” and “t”; “s” and “sh” and “f”, etc. While difficult from an audio perspective, the mouth does form different shapes in forming these phonemes. In fact, each phoneme is defined by a unique positioning of at least one of a user's lips 170, tongue 172 and/or teeth 174 relative to each other.

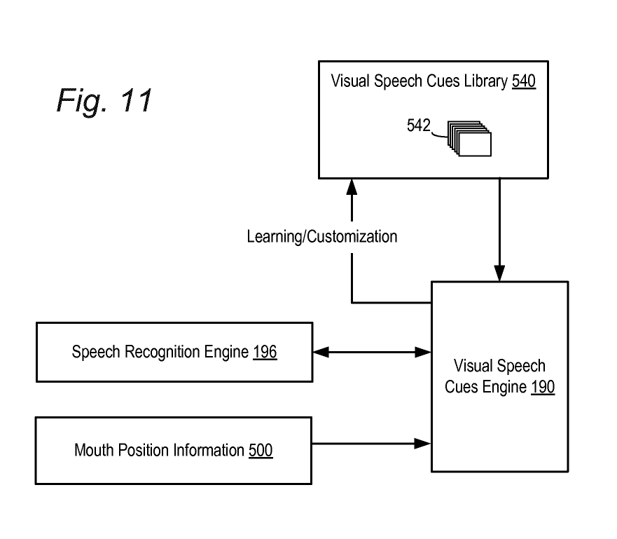

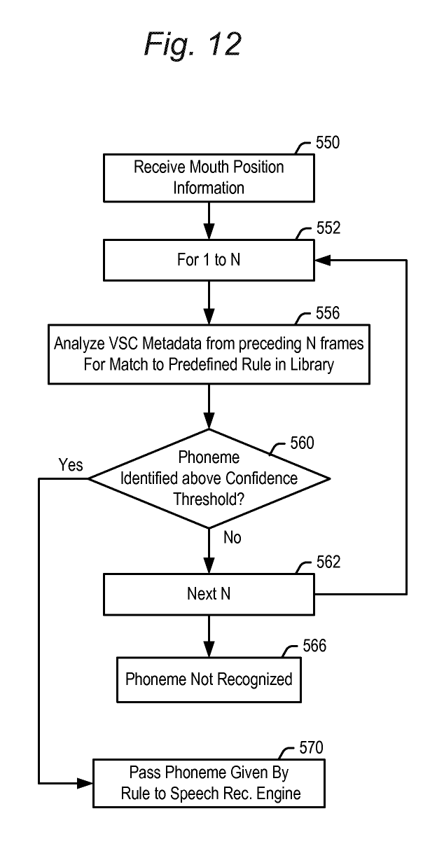

In accordance with the present technology, these different positions may be detected in the image data from the depth camera 26 and/or RGB camera 28. This image data is forwarded to the VSC engine 190 in step 420, which attempts to analyze the data and determine the phoneme mouthed by the user. The operation of VSC engine 190 is explained below with reference to FIGS. 11 and 12.

Various techniques may be used by the VSC engine 190 to identify upper and lower lips, tongue and/or teeth from the image data. Such techniques include Exemplar and centroid probability generation, which techniques are explained for example in U.S. patent application Ser. No. 12/770,394, entitled “Multiple Centroid Condensation of Probability Distribution Clouds,” which application is incorporated by reference herein in its entirety. Various additional scoring tests may be run on the data to boost confidence that the mouth is properly identified. The fact that the lips, tongue and/or teeth will be in a generally known relation to each other in the image data may also be used in the above techniques in identifying the lips, tongue and/or teeth from the data.

In embodiments, the speech recognition engine 196 and the VSC engine 190 may operate in conjunction with each other to arrive at a determination of a phoneme where the engines working separately may not. However, in embodiments, they may work independently of each other.

After several frames of data, the speech recognition engine 196 with the aid of the VSC engine 190, may recognize a question, command or statement spoken by the user 18. In step 422, the system 10 checks whether a spoken question, command or statement is recognized. If so, some predefined responsive action to the question, command or statement is taken in step 426, and the system returns to step 402 for the next frame of data. If no question, command or statement is recognized, the system returns to step 402 for the next frame without taking any responsive action. If a user appears to be saying something but the words are not recognized, the system may prompt the user to try again or phrase the words differently.

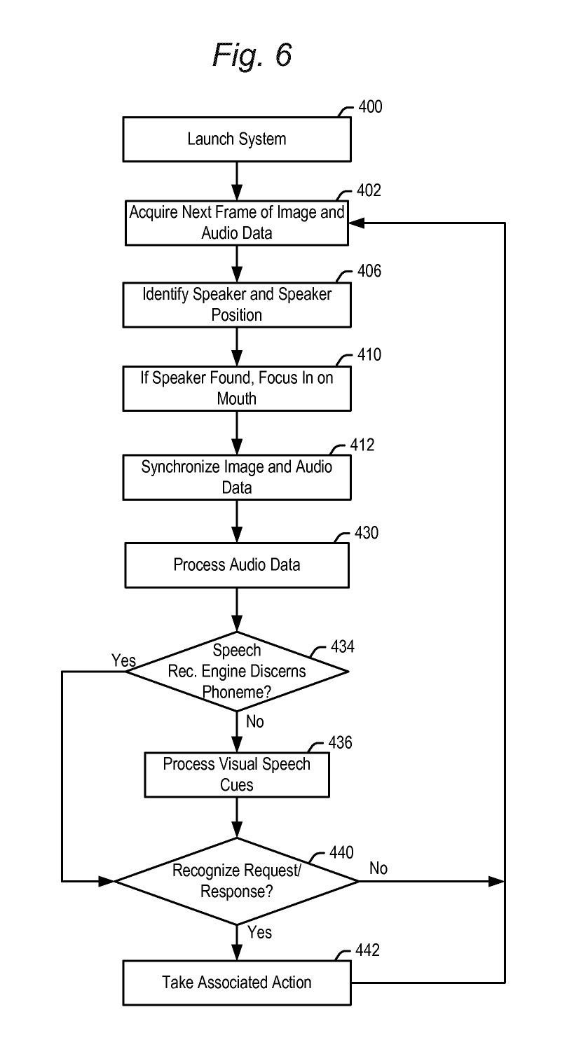

In the embodiment of FIG. 5, the VSC engine 190 assists the speech recognition engine 196 in each frame. In an alternative embodiment shown in FIG. 6, the VSC engine may assist only when the speech recognition engine 196 is having difficulty. In FIG. 6, step 400 of launching the system through step 412 of synchronizing the audio and image data are the same as described above with respect to FIG. 5. In step 430, the speech recognition engine 196 processes the audio data. If it is successful and no ambiguity exists in identifying the spoken phoneme, the system may jump to step 440 of checking whether a question, command or statement is recognized and, if so, responding in step 442, as described above.

On the other hand, if the speech recognition engine is unable to discern a phoneme in step 434, the image data captured of a user's mouth may then be forwarded to the VSC engine 190 for analysis. In the prior embodiment of FIG. 5, the VSC engine looks for all phonemes, and as such, has many different rules to search through. In the embodiment of FIG. 6, the VSC engine 190 may focus on a smaller subset of known, problematic phonemes for recognition. This potentially allows for a more detailed analysis of the phonemes in the smaller subset.

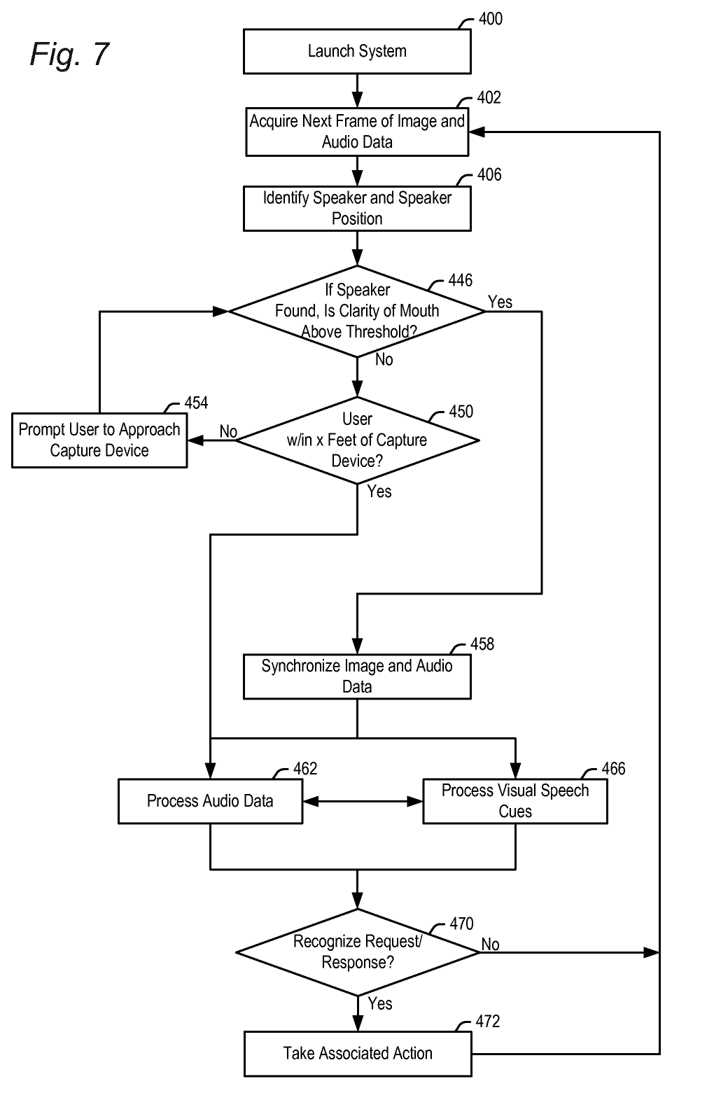

In the embodiments of FIGS. 5 and 6, the depth camera 26 and/or RGB camera 28 focus in on the head and/or mouth of a user. However, as noted, in further embodiments, one or both of the cameras 26, 28 may obtain the image data needed to recognize phonemes without zooming in. Such an embodiment is now described with respect to FIG. 7.

Step 400 of launching the system 10 through step 406 of identifying a speaker and speaker position are as described above. In step 446, if a speaker was identified, the system checks whether the clarity of the image data is above some objective, predetermined threshold. Three factors may play into the clarity of the image for this determination.

The first factor may be resolution, i.e., the number of pixels in the image. The second factor may be proximity, i.e., how close the speaker is to the capture device 20. And the third factor may be light energy incident on the user. Given the high frame rates that may be used in the present technology, there may be a relatively short time for the image sensors in cameras 26 and 28 to gather light. Typically, a depth camera 26 will have a light projection source. RGB camera 28 may have one as well. This light projection provides enough light energy for the image sensors to pick up a clear image, even at high frame rates, as long as the speaker is close enough to the light projection source. Light energy is inversely proportional to the square of the distance between the speaker and the light projection source, so the light energy will decrease rapidly as a speaker gets further from the capture device 20.

These three factors may be combined into an equation resulting in some threshold clarity value. The factors may vary inversely with each other and still satisfy the threshold clarity value, taking into account that proximity and light energy will vary with each other and that light energy varies with a square of the distance. Thus for example, where the resolution is low, the threshold may be met where the user is close to the capture device. Conversely, where the user is farther away from the camera, the clarity threshold may still be met where the resolution of the image data is high.

In step 446, if the clarity threshold is met, the image and audio data may be processed to recognize the speech as explained below. On the other hand, if the clarity threshold is not met in step. 446, the system may check in step 450 how far the speaker is from capture device 20. This information is given by the depth camera 26. If the speaker is beyond some predetermined distance, x, the system may prompt the speaker to move closer to the capture device 20 in step 454. As noted above, in normal conditions, the system may obtain sufficient clarity of a speaker's mouth for the present technology to operate when the speaker is 6 feet or less away from the capture device (though that distance may be greater than that in further embodiments). The distance, x, may for example be between 2 feet and 6 feet, but may be closer or farther than this range in further embodiments.

If the clarity threshold is not met in step 446, and the speaker is within the distance, x, from the capture device, then there may not be enough clarity for the VSC engine 190 to operate for that frame of image data. The system in that case may rely solely on the speech recognition engine 196 for that frame in step 462.

On the other hand, if the clarity threshold is met in step 446, the image and audio data may be processed to recognize the speech. The system may proceed to synchronize the image and audio data in step 458 as explained above. Next, the audio data may be sent to the speech recognition engine 196 for processing in step 462 as explained above, and the image data may be sent to the VSC engine 190 for processing in step 466 as explained above. The processing in steps 462 and 466 may occur contemporaneously, and data between the speech recognition engine 196 and VSC engine 190 may be shared. In a further embodiment, the system may operate as described above with respect to the flowchart of FIG. 6. Namely, the audio data is sent first to the speech recognition engine for processing, and the image data is sent to the VSC engine only if the speech recognition engine is unable to recognize the phoneme in the speech.

After processing by the speech recognition engine 196 and, possibly, the VSC engine 190, the system checks whether a request, command or statement is recognized in step 470 as described above. If so, the system takes the associated action in step 472 as described above. The system then acquires the next frame of data in step 402 and the process repeats.

The present technology for identifying phonemes by image data simplifies the speech recognition process. In particular, the present system is making use of resources that already exist in a NUI system; namely, the existing capture device 20, and as such, adds no overhead to the system. The VSC engine 190 may allow for speech recognition without having to employ word recognition, grammar and syntactical parsing, contextual inferences and/or a variety of other processes which add complexity and latency to speech recognition. Thus, the present technology may improve processing times for speech recognition. Alternatively, the above algorithms and current processing times may be kept, but the present technology used as another layer of confidence to the speech recognition results.

The operation of an embodiment of the VSC engine 190 will now be explained with reference to the block diagram of FIG. 11 and the flowchart of FIG. 12. In general, various positions of the upper lip, lower lip, tongue and/or teeth in forming specific phonemes may be cataloged for each phoneme to be tracked. Once cataloged, the data may be stored in a library 540 as rules 542. These rules define baseline positions of the lips, tongue and/or teeth for different phonemes. However, different users have different speech patterns and accents, and different users will pronounce the same intended phoneme different ways.

Accordingly, the VSC engine 190 includes a learning/customization operation. In this operation, where the speech recognition engine is able to recognize a phoneme over time, the positions of the lips, tongue and/or teeth when a speaker mouthed the phoneme may be noted and used to modify the baseline data values stored in library 540. The library 540 may have a different set of rules 542 for each user of a system 10. The learning customization operation may go on before the steps of the flowchart of FIG. 12 described below, or contemporaneously with the steps of the flowchart of FIG. 12.

Referring now to FIG. 12, the VSC engine 190 receives mouth position information 500 in step 550. The mouth position information may include a variety of parameters relating to position and/or motion of the user's lips, tongue and/or teeth, as detected in the image data as described above. Various image classifiers may also be used to characterize the data, including for example hidden Markov Model or other Bayesian techniques to indicate the shape and relative position of the lips, tongue and/or teeth.

Some phonemes may be formed by a single lip, tongue and/or teeth position (like vowels or fricatives). Other phonemes may be formed of multiple lip, tongue and/or teeth positions (like the hold and release positions in forming the letter “p” for example). Depending on the frame rate and phoneme, a given phoneme may be recognizable from a single frame of image data, or only recognizable over a plurality of frames.

Accordingly, in steps 552 through 562, the VSC engine 190 iteratively examines frames of image data in successive passes to see if image data obtained from the depth camera 26 and/or RGB camera 28 matches the data within a rule 542 to within some predefined confidence level. In particular, the first time through steps 552 through 556, the VSC engine examines the image data from the current frame against rules 542. If no match is found, the VSC engine examines the image data from the last two frames (current and previous) against rules 542 (assuming N is at least 2). If no match is found, the VSC engine examines the image data from the last three frames against rules 542 (assuming N is at least 3). The value of N may be set depending on the frame rate and may vary in embodiments between 1 and, for example, 50. It may be higher than that in further embodiments.

A stored rule 542 describes when particular positions of the lips, tongue and/or teeth indicated by the position information 500 are to be interpreted as a predefined phoneme. In embodiments, each phoneme may have a different, unique rule or set of rules 542. Each rule may have a number of parameters for each of the lips, tongue and/or teeth. A stored rule may define, for each such parameter, a single value, a range of values, a maximum value, and a minimum value.

In step 560, the VSC engine 190 looks for a match between the mouth image data and a rule above some predetermined confidence level. In particular, in analyzing image data against a stored rule, the VSC engine 190 will return both a potential match and a confidence level indicating how closely the image data matches the stored rule. In addition to defining the parameters required for a phoneme, a rule may further include a threshold confidence level required before mouth position information 500 is to be interpreted as that phoneme. Some phonemes may be harder to discern than others, and as such, require a higher confidence level before mouth position information 500 is interpreted as a match to that phoneme.

Once a confidence level has been determined by the VSC engine 190, the engine 190 checks in step 560 whether that confidence level exceeds a threshold confidence for the identified phoneme. If so, the VSC engine 190 exits the loop of steps 552 through 562, and passes the identified phoneme to the speech recognition engine in step 570. On the other hand, if the VSC engine makes it through all iterative examinations of N frames without finding a phoneme above the indicated confidence threshold, the VSC engine 190 returns the fact that no phoneme was recognized in step 566. The VSC engine 190 then awaits the next frame of image data and the process begins anew.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. In a system comprising a computing environment coupled to a capture device for capturing information from a scene, a method of recognizing phonemes from image data, comprising:
a) receiving information from the scene including image data and audio data;
b) capturing image data relating to a position of at least one of the speaker's lips, tongue and/or teeth; and
c) comparing the image data captured in said step e) against stored rules to identify a phoneme indicated by the image data captured in said step e).

2. The method of claim 1, further comprising the steps of:
d) identifying a speaker in the scene,
e) locating a position of the speaker within the scene,
f) obtaining greater image detail on speaker within the scene relative to other areas of the scene, and
g) synchronizing the image data to the audio data.

3. The method of claim 2, further comprising the step h) of processing the audio data by a speech recognition engine for recognizing speech from audio data.

4. The method of claim 3, said step f) of comparing the captured image data against stored rules to identify a phoneme occurring contemporaneously with said step h) of processing the audio data by a speech recognition engine.

5. The method of claim 3, said step f) of comparing the captured image data against stored rules to identify a phoneme occurring after the speech recognition engine is unable to identify a phoneme from the audio data in said step h).

6. The method of claim 1, said step f) of comparing the captured image data against stored rules to identify a phoneme comprising the step j) of iteratively comparing data for the current frame and past frames of image data against the stored rules.

7. The method of claim 6, said step j) of iteratively comparing data for the current frame and past frames of image data against the stored rules comprising selecting the number of past frames based on a frame rate at which image data is captured.

8. The method of claim 1, said step b) of identifying a speaker in the scene comprising the step of analyzing image data and comparing that to a location of the source of audio data.

9. The method of claim 1, said step c) of obtaining greater image detail on the one or more areas of interest within the scene comprising the step of performing one of a mechanical zoom or digital zoom to focus on at least one area of interest in the one or more areas of interest.

10. In a system comprising a computing environment coupled to a capture device for capturing information from a scene, a method of recognizing phonemes from image data, comprising:
a) receiving information from the scene including image data and audio data;
b) identifying a speaker in the scene;
c) locating a position of the speaker within the scene;
d) measuring a plurality of parameters to determine whether a clarity threshold is met for obtaining image data relating to a position of at least one of the speaker's lips, tongue and/or teeth;
e) capturing image data relating to a position of at least one of the speaker's lips, tongue and/or teeth if it is determined in said step d) that the clarity threshold is met; and
f) identifying a phoneme indicated by the image data captured in said step e) if it is determined in said step d) that the clarity threshold is met.

11. The method of claim 10, said step d) of measuring a plurality of parameters to determine whether a clarity threshold is met comprises the step of measuring at least one of:
d1) a resolution of the image data,
d2) a distance between the speaker and the capture device, and
d3) an amount of light energy incident on the speaker.

12. The method of claim 11, wherein parameter d1) may vary inversely with parameters d2) and d3) and the clarity threshold is still met.

13. The method of claim 10, further comprising the step g) of synchronizing the image data to the audio data by the step of time stamping the image data and audio data and comparing time stamps.

14. The method of claim 13, further comprising the step h) of processing the audio data by a speech recognition engine for recognizing speech from audio data.

15. The method of claim 14, said step f) comprising the step of comparing the captured image data against stored rules to identify a phoneme, said step f) occurring contemporaneously with said step h) of processing the audio data by a speech recognition engine.

16. The method of claim 14, said step f) comprising the step of comparing the captured image data against stored rules to identify a phoneme, said step f) occurring after the speech recognition engine is unable to identify a phoneme from the audio data in said step h).

17. A computer-readable storage medium for programming a processor to perform a method of recognizing phonemes from image data, the method comprising:
a) capturing image data and audio data from a capture device;
b) setting a frame rate at which the capture device captures images based on a frame rate determined to capture movement required to determine lip, tongue and/or teeth positions in forming a phoneme;
c) setting a resolution of the image data to a resolution that does not result in latency in the frame rate set in said step b);
d) prompting a user to move to a position close enough to the capture device for the resolution set in said step c) to obtain an image of the user's lips, tongue and/or teeth with enough clarity to discern between different phonemes;
e) capturing image data from the user relating to a position of at least one of the speaker's lips, tongue and/or teeth; and
f) identifying a phoneme based on the image data captured in said step e).

18. The computer-readable storage medium of claim 17, further comprising the step of generating stored rules including information on the position of lips, tongue and/or teeth in mouthing a phoneme, the stored rules used for comparison against captured image data to determine whether the image data indicates a phoneme defined in a stored rule, the stored rules further including a confidence threshold indicating how closely captured image data needs to match the information in the stored rule in order for the image data to indicate the phoneme defined in the stored rule.

19. The computer-readable storage medium of claim 18, further comprising the step iteratively comparing data for the current frame and past frames of image data against the stored rules to identify a phoneme.

20. The computer-readable storage medium of claim 17, further comprising the step g) of processing the audio data by a speech recognition engine for recognizing speech from audio data, said step f) of identifying a phoneme based on the captured image data performed only upon the speech recognition engine failing to identify recognize speech from the audio data.
